(19) United States
(12) Patent Application Publication
(10) Pub. No.: US 2026/0176048 A1
(43) Pub. Date: Jun. 25, 2026

(54) AIR PUMP STRUCTURE OF A PACKAGE AND THE CONNECTED BOTTLE

(71) Applicant: HONOR PACKAGING TECHNOLOGY (HUIZHOU) CO.,LTD, Huizhou (CN)

(72) Inventors: HU LIN, Shenzhen (CN); ZEMIN LIU, Guangzhou (CN)

(21) Appl. No.: 19/539,170

(22) Filed: Feb. 13, 2026

(30) Foreign Application Priority Data
Aug. 8, 2025 (CN) 202521688020.2

(51) Int. Cl. B65D 81/05; B05B 11/00; B05B 11/02; B05B 11/10; B65D 81/02

(52) U.S. Cl. CPC B65D 81/052; B05B 11/00444; B05B 11/026; B05B 11/1069; B65D 81/02

(57) ABSTRACT

Provided are an air pump structure of a packaging bottle and the packaging bottle, the air pump structure includes an elastic component with openings at two ends and a wrinkle outer wall. An upper end of the elastic component is provided with a domed-top raise, a lower end of the domed-top raise is provided with an opening and a through groove on an outer wall, a lower end of the elastic component is provided with a support seat, and an inner wall of the support seat is provided with a one-way valve. The domed-top raise is arranged in a semi shuttle shape, and the lower end of the domed-top raise is fixedly connected to a top of the elastic component. There are one or a plurality sets of through grooves that are arranged in a rotation array with a center line of the domed-top raise as a rotation axis

### CROSS-REFERENCE TO RELATED APPLICATIONS

This application claims priority to Chinese Patent Application No. 202521688020.2, filed on Aug. 8, 2025, which is hereby incorporated by reference in its entirety.

### TECHNICAL FIELD

The present disclosure relates to the field of packaging bottle technologies, and in particular, to an air pump structure of a package bottle and the package bottle.

### BACKGROUND

A packaging bottle is a storage device used to store liquids or colloids. In the field of daily chemical products, they are mainly used to store cleanser, shampoo to cream shampoo, conditioner to hair mask, skincare cream, and food sauces, etc. It includes various types of packaging. Some packaging bottles can undergo non elastic deformation, so that an operator can press the packaging bottle to deform and discharge the stored items. Some packaging bottles also have an air pump structure at the top opening, which can force the stored items inside the packaging bottle to be discharged through the air pump structure.

In existing technology, common air pump structures mainly include two types. One mainly uses elasticity to drive the piston block inside the air pump structure to move back and forth, thereby using negative pressure to achieve discharge. The other uses a valve as a one-way valve to restrict the movement of stored items and air in one direction to achieve discharge. In contrast, the valve is less prone to pollution and less likely to cause damage to the stored items during use and has a better effect. However, the valve itself has a limited thickness, so its elastic deformation frequency is also limited. After repeated deformation, its elastic deformation will decrease, and it will be unable to continue to achieve one-way limit function. This will lead to a decrease in an overall sealing performance of the device, and the products stored inside the device will contact air and moisture water vapor. Therefore, an air pump structure of a packaging and its connected bottle are proposed to solve the above problems.

### SUMMARY

In order to compensate for the above shortcomings, the present disclosure provides an air pump structure of a package and the connected bottle, aiming to improve the problem of “the valve will lose its sealing ability after a period of use, which will cause the products inside the device to contact with air and water vapor” in the existing technology.

In order to achieve the above objectives, the present disclosure adopts the following technical solution: an air pump structure of a packaging bottle, including:
an elastic component, which is hollow inside, with openings at two ends and a wrinkle outer wall, an upper end of the elastic component is provided with a domed-top raise, and a lower end of the domed-top raise is provided with an opening and a through groove on an outer wall, a lower end of the elastic component is provided with a support seat, and an inner wall of the support seat is provided with a one-way valve.

In some embodiments of the present disclosure, the domed-top raise is arranged in a semi shuttle shape, and the lower end of the domed-top raise is fixedly connected to a top of the elastic component.

In some embodiments of the present disclosure, there are one or a plurality sets of through grooves.

In some embodiments of the present disclosure, the plurality sets of through grooves are arranged in a rotation array with a center line of the domed-top raise as a rotation axis.

In some embodiments of the present disclosure, there are one or a plurality sets of wrinkles on the outer wall of the elastic component.

In some embodiments of the present disclosure, a packaging bottle, further includes:
a bottle body configured to accommodate items, an inner wall of the bottle body is provided with a piston block, a fixing seat is provided at an inner wall of the bottle body close to a top position, an inner wall of the fixing seat is clamped with a discharge pipe, and a sealing plug is configured to be inserted at a top opening of the discharge pipe, an outer wall of the fixing seat is sleeved with a cover body.

In some embodiments of the present disclosure, a top of the sealing plug is provided with a convex edge, and the convex edge is horizontal.

In some embodiments of the present disclosure, an upper surface of the convex edge is attached to a top of an inner wall of the cover body, and the domed-top raise is configured to be inserted into an inner wall of the discharge pipe.

In some embodiments of the present disclosure, a wrinkle shaped outer wall of the elastic component includes a circular ring shape and a spiral shape.

The present disclosure has the following beneficial effects.

1. In the present disclosure, the domed-top raise is used to replace the valve structure in traditional technology. When discharging, the discharge pipe can be pressed to force the top of the domed-top raise to move downward, so that the through groove on the outer wall will be forced to be opened. At this time, the stored items inside the bottle body can be discharged outward through the through groove. Compared with the valve structure, the domed-top raise itself is thicker, so it has better durability. By using the domed-top raise to achieve one-way positioning, the service life of the overall device can be improved, which can maintain long-term sealing and reduce the probability of the product meeting air and water vapor.

### BRIEF DESCRIPTION OF DRAWINGS

FIG. 1 is a schematic sectional view of a three-dimensional structure of an overall device in the present disclosure.

FIG. 2 is a schematic diagram of a three-dimensional structure disassembly of a packaging bottle in the present disclosure.

FIG. 3 is a schematic diagram of a three-dimensional structure of an elastic component in the present disclosure.

FIGS. 4A, 4B and 4C are schematic front views of the domed-top raise in Embodiment 1, Embodiment 2, and Embodiment 3, respectively. FIG. 4D is an elastic component (or annular vessel) made into the annular vessel with spiral-up screwing. FIG. 4E is similar to FIG. 4D but with the screwing in a different shape.

FIG. 5 is a schematic sectional view of a single pressing rebound process in the present disclosure.

FIG. 6 is a schematic sectional view of a secondary pressing rebound process in the present disclosure.

Numeral reference: 1-bottle body; 2-piston block; 3-fixing seat; 4-elastic component; 41-support seat; 5-domed-top raise; 51-through groove; 6-discharge pipe; 7-cover body; 8-sealing plug; 81-convex edge; 9-one-way valve.

### DESCRIPTION OF EMBODIMENTS

The following will provide a clear and complete description of the technical solution in the embodiments of the present disclosure, based on the accompanying drawings. Obviously, the embodiments described are only a part of the embodiments of the present disclosure, not all of them. Based on the embodiments in the present disclosure, all other embodiments obtained by those skilled in the art without creative work are within the protection scope of the present disclosure.

### Embodiment 1

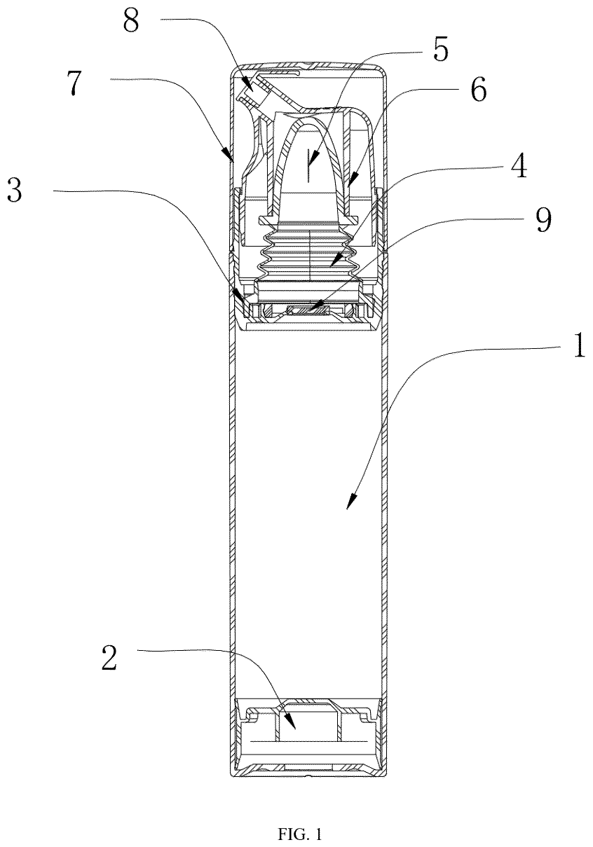

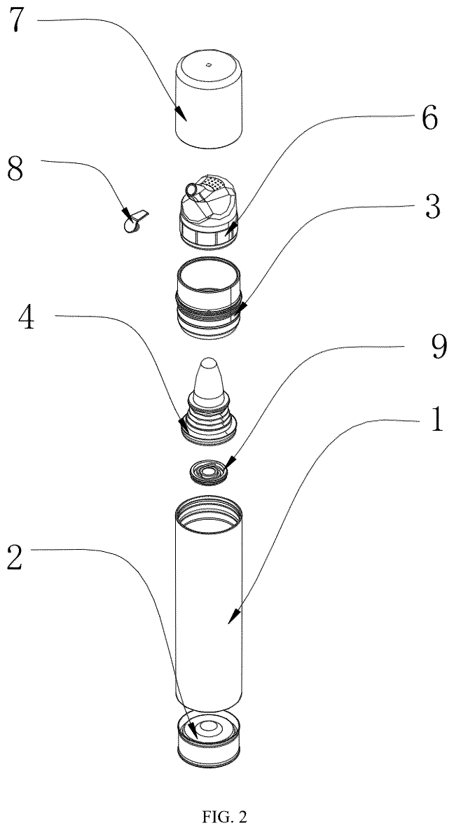

Referring to FIGS. 1-3, the present disclosure provides an embodiment of an air pump structure for a packaging bottle, including an elastic component 4, which is hollow inside and has openings at both upper and lower ends. The elastic component 4 is made of elastic material and has elastic deformation ability. An outer wall of the elastic component 4 is arranged in a wrinkle shape to prevent damage to the elastic component 4 during deformation. An upper end of the elastic component 4 is provided with a domed-top raise 5, and a lower end of the domed-top raise 5 is configured to be in an open shape and with a through groove 51 on an outer wall. The domed-top raise 5 is also made of elastic material. When its upper and lower ends are close to each other, its outer wall will expand outward, which can force or when the stored items are squeezed from the inside to the outside against an inner wall of the domed-top raise 5. An outer wall of the domed-top raise 5 will also expand outward, which in turn drives the through groove 51 to be opened. A lower end of the elastic component 4 is provided with a support seat 41, an inner wall of the support seat 41 is provided with a one-way valve 9.

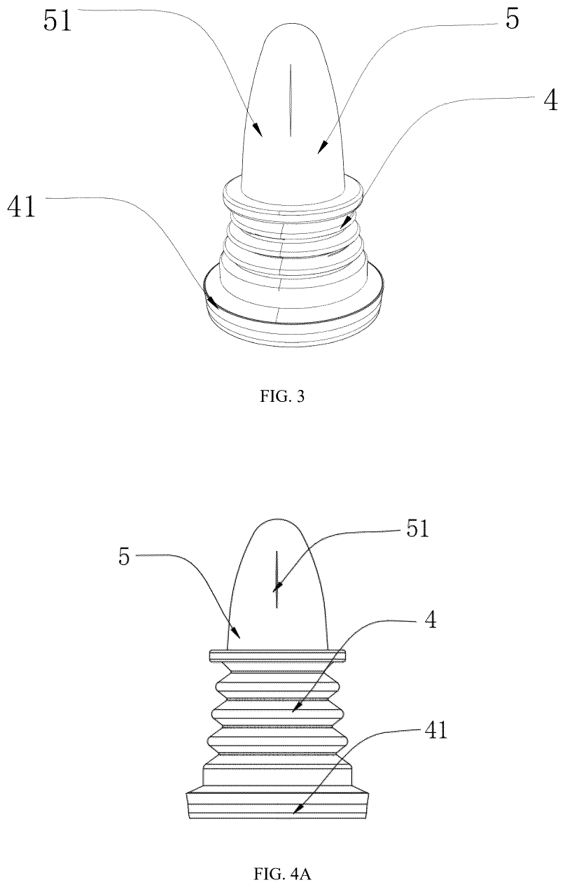

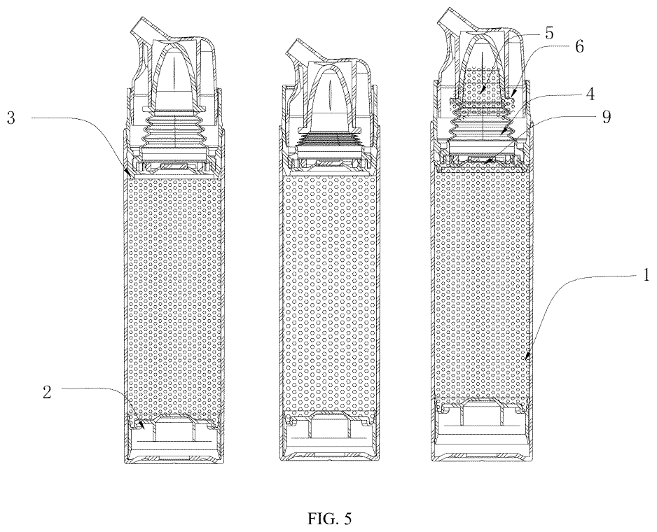

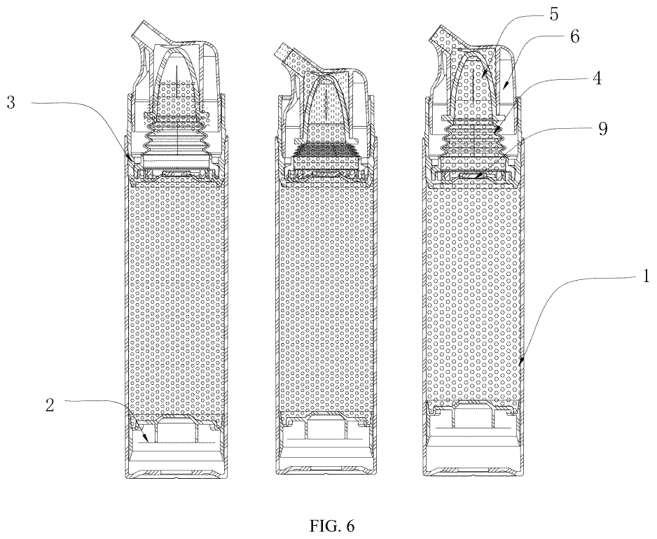

Referring to FIGS. 3, 5, and 6, the domed-top raise 5 is arranged in a semi shuttle shape, which allows a top of the domed-top raise 5 to expand uniformly outward when compressed. The lower end of the domed-top raise 5 is fixedly connected to a top of the elastic component 4. There are one or a plurality sets of through grooves 51, and a discharge amount of a single press can be controlled by increasing or decreasing the number of through grooves 51. A plurality of sets of through grooves 51 are arranged in a rotation array with a center line of the domed-top raise 5 as a rotation axis. A circular array allows the domed-top raise 5 to deform uniformly when compressed, and the number of wrinkles on the outer wall of the elastic component 4 can be one to a plurality of sets.

Referring to FIGS. 1-3, air pump structure of a package and the connected bottle 1 configured to accommodate items. The bottle body 1 is a cylindrical structure with openings at upper and lower ends, and a piston block 2 is provided on an inner wall of the bottle body 1. A space on an inner wall of the bottle body 1 close to the piston block 2 is a storage area that can be used to store the items. A fixing seat 3 is provided at an inner wall of the bottle body 1 close to a top position, and an inner wall of the fixing seat 3 is clamped with a discharge pipe 6. The discharge pipe 6 can move up and down on the inner wall of the fixing seat 3. A sealing plug 8 is configured to be inserted at a top opening of the discharge pipe 6. When the items need to be stored for a long time, the top opening of the discharge pipe 6 can be closed using the sealing plug 8. In this way, to prevent oxidation or leakage of materials inside bottle body 1, it is necessary to remove the sealing plug 8 before using the overall device for a first time. An outer wall of the fixing seat 3 is sleeved with a cover body 7, the cover body 7 can be used to seal the overall device. When not in daily use, the cover body 7 can be directly used to seal the air pump structure. The wrinkle shaped outer wall of the elastic component includes but is not limited to circular and spiral shapes.

A top of the sealing plug 8 is provided with a convex edge 81, and the convex edge 81 facilitates an operator to remove the sealing plug 8 from the top opening of the discharge pipe 6. The convex edge 81 is horizontal, and an upper surface of the convex edge 81 is in contact with a top of an inner wall of the cover body 7. The cover body 7 can further increase the stability of the sealing plug 8 by squeezing the convex edge 81, and the domed-top raise 5 is configured to be inserted into an inner wall of the discharge pipe 6.

### Embodiment 2

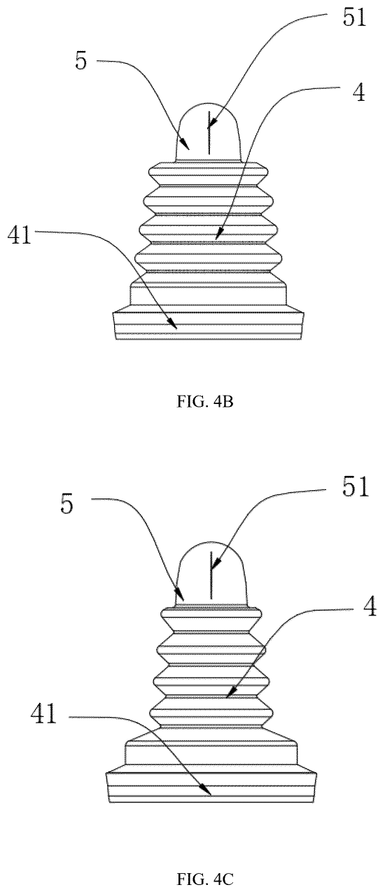

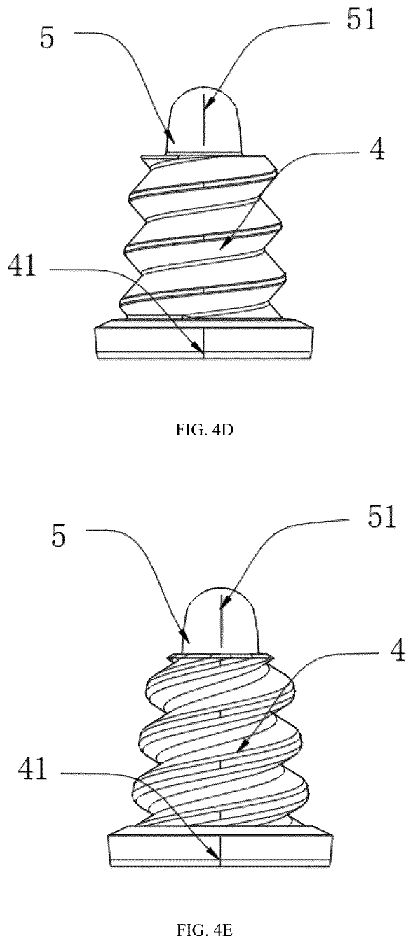

Referring to FIGS. 1, 2, and 4A, 4B, 4C, 4D and 4E, a difference between this embodiment 2 and embodiment 1 is that in this embodiment 2, the domed-top raise 5 is arranged in a conical shape, and the top of the domed-top raise 5 is arranged in a spherical shape. Due to its small size, its single discharge amount is also relatively small. The device provided with this domed-top raise 5 is suitable for storing small measuring items such as toothpaste during use.

### Embodiment 3

Referring to FIGS. 1, 2 and 4A, 4B, 4C, 4D and 4E, a difference between embodiment 3 and embodiment 2 is that a diameter of the elastic component 4 in embodiment 3 is smaller, so the air discharged by a single deformation is less, which can further reduce the discharge amount of a single press. The device provided with the domed-top raise 5 is suitable for storing small quantities of essence and other articles with strong liquidity when used.

Embodiment 4

Referring to FIGS. 1, 2, and 4A, 4B, 4C, 4D and 4E, a difference between this embodiment 4 and embodiment 3 is that the elastic component 4 in this embodiment 4 adopts a spiral structure, which enables the elastic component to have better elasticity during use. The elastic component 4 shown in embodiment 4 adopts a single helix spiral structure.

### Embodiment 5

Referring to FIGS. 1, 2, and 4A, 4B, 4C, 4D and 4E, a difference between this embodiment 5 and embodiment 4 is that the elastic component 4 in this embodiment 5 adopts a double helix spiral structure, which can further enhance the elasticity of the elastic component 4, but at the same time, it may also make it difficult to press the elastic component 4 during use, making it suitable for pumping liquids with poor fluidity and high viscosity, such as shower gel, etc.

Working principle: when the operator needs to use the stored items inside the bottle body 1, he can press the discharge pipe 6 to drive the domed-top raise 5 and the elastic component 4 to move downwards. In this way, a wrinkle part of the elastic component 4 will be compressed downwards, and a downward movement of the elastic component 4 will squeeze the items stored on its inner wall, forcing the items to move upwards. In this way, the items will squeeze the inner wall of the domed-top raise 5 and force the domed-top raise 5 to expand outward, which can drive the through groove 51 to be opened. At this time, the items can leave the inner side of the domed-top raise 5 through the through groove 51. Then, the items can be discharged from the inner side of the discharge pipe 6 through the top opening of the discharge pipe 6, thereby achieving a discharge. When the operator releases the discharge pipe 6, the elastic component 4 will use its own elasticity to force the domed-top raise 5 to expand outward. The deformation will be restored, so that it will use negative pressure to attract the stored items inside the bottle body 1 through the one-way valve 9 and refill an inner wall of the elastic component 4.

When using it for the first time, since the elastic component 4 is not filled inside, the operator needs to repeat the above press and release steps first. In this way, the negative pressure generated by the rebound of the elastic component 4 can be used to attract the stored items inside the bottle body 1 and store them inside the elastic component 4 before a normal press, and discharging can be carried out.

Finally, it should be noted that the above description is only preferred embodiments of the present disclosure and is not intended to limit the present disclosure. Although the present disclosure has been described in detail with reference to the embodiments, those skilled in the art may still modify the technical solutions described in the embodiments or equivalently replace some of the technical features. Any modifications, equivalent replacements, improvements, etc. made within the spirit and principles of the present disclosure should be included in the protection scope of the present disclosure.

What is claimed is:

1. An air pump structure of a packaging bottle, comprising: an elastic component, which is hollow inside, with openings at two ends and a wrinkle outer wall,
an upper end of the elastic component is provided with a domed-top raise, and a lower end of the domed-top raise is provided with an opening and a through groove on an outer wall,
a lower end of the elastic component is provided with a support seat, and an inner wall of the support seat is provided with a one-way valve.

2. The air pump structure of a packaging bottle according to claim 1, wherein the domed-top raise is arranged in a semi shuttle shape, and the lower end of the domed-top raise is fixedly connected to a top of the elastic component.

3. The air pump structure of a packaging bottle according to claim 1, wherein there are one or a plurality sets of through grooves.

4. The air pump structure of a packaging bottle according to claim 3, wherein the plurality sets of through grooves are arranged in a rotation array with a center line of the domed-top raise as a rotation axis.

5. The air pump structure of a packaging bottle according to claim 1, wherein there are one or a plurality sets of wrinkles on the outer wall of the elastic component.

6. A packaging bottle, comprising: the air pump structure according to claim 1, wherein the package bottle further comprises:
a bottle body configured to accommodate items, an inner wall of the bottle body is provided with a piston block, a fixing seat is provided at an inner wall of the bottle body close to a top position, an inner wall of the fixing seat is clamped with a discharge pipe, and a sealing plug is configured to be inserted at a top opening of the discharge pipe, an outer wall of the fixing seat is sleeved with a cover body.

7. The packaging bottle according to claim 6, wherein a top of the sealing plug is provided with a convex edge, and the convex edge is horizontal.

8. The packaging bottle according to claim 7, wherein an upper surface of the convex edge is attached to a top of an inner wall of the cover body, and the domed-top raise is configured to be inserted into an inner wall of the discharge pipe.

9. The packaging bottle according to claim 7, wherein a wrinkle shaped outer wall of the elastic component comprises a circular ring shape and a spiral shape.
